(19) United States
(12) Patent Application Publication
(10) Pub. No.: US 2007/0187946 A1
(43) Pub. Date: Aug. 16, 2007

(54) Print-on-demand tamper evident labels

(76) Inventor: Richard J. Shaieb, Rochester, MI (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 11/353,343

(22) Filed: Feb. 14, 2006

(51) Int. Cl. B42D 15/00; B32B 33/00; B32B 37/26; B32B 38/04; B32B 9/00; B32B 38/14

(52) U.S. Cl. 283/81; 156/289; 156/256; 156/277; 428/195.1; 428/41.8; 428/42.1

(57) ABSTRACT

A tamper evident label includes a first portion formed of a first material. The first portion is defined by at least a first top surface and a first bottom surface. The label also includes a second portion defined by at least a second edge and a printable portion. The second portion is defined by at least a second top surface and a second bottom surface. A release coating inhibits adherence of the second portion to at least portions of the first portion. A third portion is coupled to the printable portion. The third portion is defined by at least a third top surface and a third bottom surface.

### TECHNICAL FIELD

The technical field relates to tamper evident labels.

### BACKGROUND

Labels may have indicia which uniquely identify the object or device to which the label is attached. Identification labels may also carry a message warning of a hazard contained within the object to which they are affixed. It is important that such identification labels should resist removal, and that they be difficult if not practically impossible to transfer. Further, if such a label is tampered with, the tampering should be obvious from the appearance of the label. Therefore, identification labels commonly incorporate features to assist the detection of tampering with the label. In some uses for identification labels that are affixed to an item, attempts to remove the label as a whole unit to be transferred to another item results in destruction of the label. However, in labels carrying a warning message, it may be desired that this message not be destroyed even if modification of the label is attempted during tampering.

Some tamper evident labels include two layers. An exposed layer is a friable, polymeric film adhered to a substance by a pressure sensitive adhesive having an adhesive bond that is greater than the tensile strength of the film layer. Attempts to remove the label generally results in rupture of the film which can be removed only in small pieces. Because the label is fragmented by an attempted removal, the indicia on the label are destroyed simultaneously, thus reducing the likelihood of label reuse.

Accordingly, tamper evident labels rely on the destruction of the label base and/or message to indicate the attempted removal of the label. These labels are generally printed with graphics prior to shipment to a user and do not permit distinctive, individual label printing.

What is needed, therefore, is a tamper evident label system that allows for the printing of desired information on demand including customized information, or information including indicia identifying a particular object to which an item is to be affixed. Such a tamper evident label would preferably leave evidence of label tampering on a surface, and may also preserve any warning message after attempted removal.

### BRIEF DESCRIPTION OF THE DRAWINGS

Referring now to the drawings, preferred illustrative embodiments are shown in detail. Although the drawings represent some embodiments, the drawings are not necessarily to scale and certain features may be exaggerated, removed, or partially sectioned to better illustrate and explain the present invention. Further, the embodiments set forth herein are not intended to be exhaustive or otherwise limit or restrict the claims to the precise forms and configurations shown in the drawings and disclosed in the following detailed description. In all drawing figures below, thicknesses are exaggerated for clarity.

FIG. 1 is an exploded, perspective view of at least portions of a label according to an embodiment.

FIG. 2 is a sectional view of the at least portions of the label of FIG. 1, taken along line 2-2, with a release liner illustrated on a second portion.

FIG. 3 is an exploded, perspective view of a label according to an embodiment, with a release liner illustrated on a third portion.

FIG. 4 is an enlarged perspective view of the label of FIG. 3.

FIG. 5 is a sectional view at least portions of the label of FIG. 3, illustrated in a first tampered configuration with some section graphics omitted for clarity.

FIG. 6 is a view of the label of FIG. 3, illustrated in a second tampered configuration.

### DETAILED DESCRIPTION

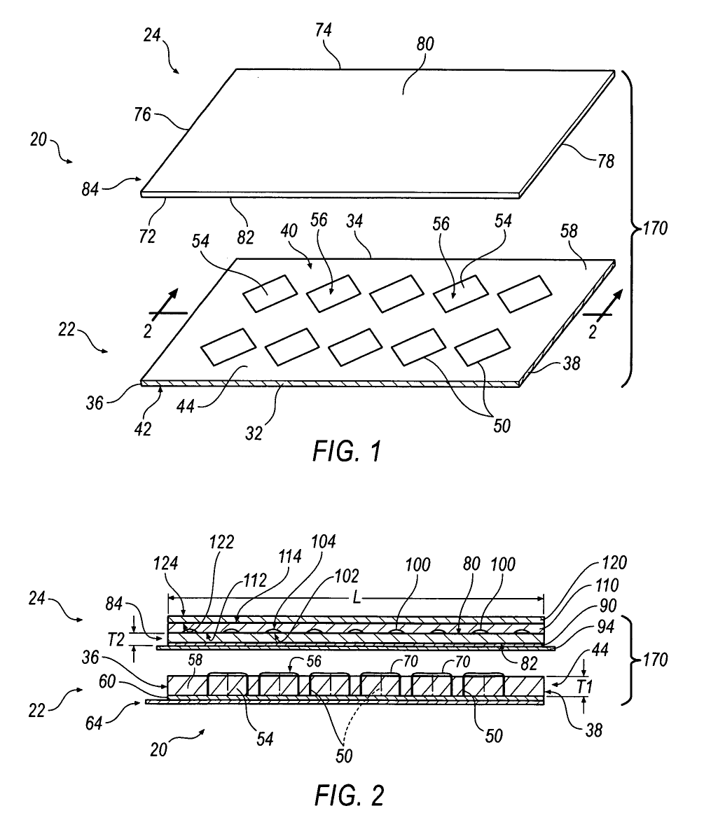

FIG. 1 illustrates a label 20 according to an embodiment. As seen in at least one of FIGS. 1-5, the label 20 includes a first layer, or first portion, 22, and a second layer, or second portion, 24. The first portion 22 includes a first linear edge 32, a second linear edge 34, a first lateral edge 36 and a second lateral edge 38, a first top surface 40, and a first bottom surface 42 defining a first body 44, having a thickness T1 therebetween. Label 20 further includes a plurality of cuts 50. In the embodiment illustrated in FIGS. 1-57, the cuts 50 extend from the first top surface 40 to the first bottom surface 42, and form segregated portions, or identifiable shapes 54, such as diamonds or any other desirable shape. Each shape 54 has a top surface 56. Accordingly, each top surface 56 is a portion of first top surface 40 when the shapes 54 are formed. The remainder of first portion 22 not including the shapes 54 forms a first lift portion 58 which may or not comprise a plurality of distinct portions of the first portion 22.

As best seen in FIG. 2, first portion 22 has an adhesive 60 on at least portions of first bottom surface 42 with a release liner 64 coupled thereto. The first portion 22 has a release coating 70 applied to at least portions of the first top surface 40. In the embodiment illustrated, the release coating 70 is applied only to the top surface 56 of the shapes 54, and not to the top surface 40 of first lift portion 58. Preferably the release coating 70 is a silicone based quick drying compound, although other suitable materials, such as synthetic polymers and wax based, water based, and Ultraviolet (UV) curable compounds could be used.

While cuts 50 in one embodiment are perforated through the thickness T1 of the first portion 22 and in a defined shape 54, the cuts 50 need only include slits of first portion 22 so as to permit the fragmentation of the first portion 22 of the label 20. That is, the cuts 50 need not extend through the thickness T1 of the first portion and/or along the entire periphery of each shape 54, as described in greater detail below.

The second portion 24 of the label 20 includes a third linear edge 72, a fourth linear edge 74, a third lateral edge 76, a fourth lateral edge 78, a second top surface 80, and a second bottom surface 82, defining a second body 84, having a thickness T2, therebetween. The second portion 24 has an adhesive 90 on at least portions of the second bottom surface 82 with a release liner 94 coupled thereto.

As illustrated in FIG. 2, according to an embodiment, second portion 24 has a patterned release material 100 coupled to portions of the second top surface 80. The patterned release material 100 has a lower surface 102 coupled to the second top surface 80, and an upper surface 104. The patterned release material 100 may be applied in a randomly applied pattern, or may be applied in a predetermined pattern to facilitate recognition, as discussed below.

With continual reference to FIG. 2, second portion 24 further includes an adhesion layer 110 coupled to at least portions of the second top surface 80. The adhesion layer 110 has an adhesion lower surface 112 and an adhesion upper surface 114. The adhesion layer 110 is preferably a varnish adhesive 116. In the embodiment illustrated in FIG. 2, portions of the adhesion lower surface 112 of the adhesion layer 110 are coupled to both the second top surface 80 and the upper surface 104 of the patterned release material 100.

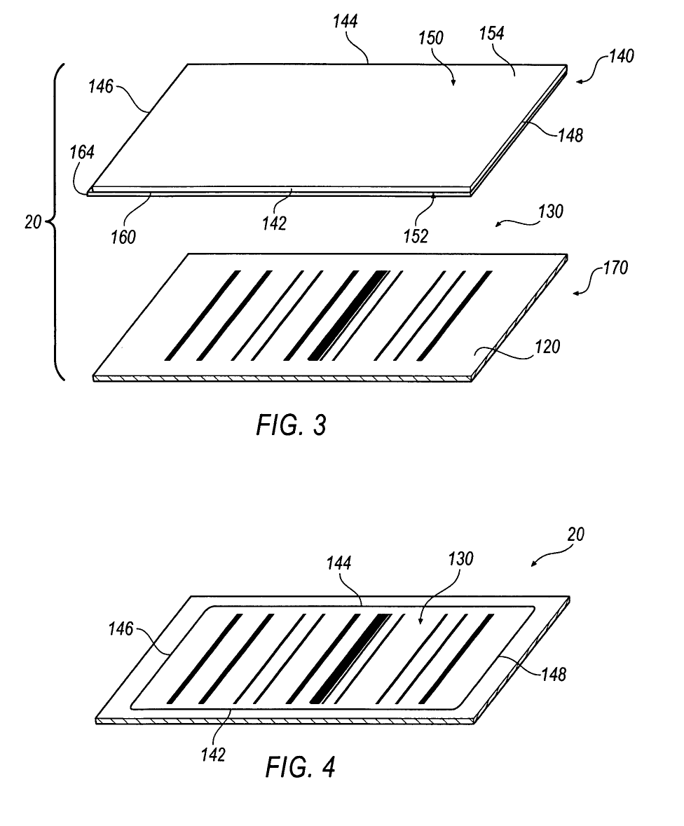

A printable layer 120 is coupled to the adhesion upper surface 114. The printable layer 120 has a printable layer lower surface 122 and a printable layer upper surface 124. The printable layer 120 is constructed of a print receptive coating, such as a thermal transfer material applied as a coating and permitted to cure. The adhesion layer 110 is used as a primer, or adhesive, to secure the printable layer 120 to the second top surface 80 and the upper surface 104. As shown in FIGS. 3 and 4, graphics 130 such as a bar code and/or other desired indicia may be applied to the printable layer 120, as discussed in greater detail below. Preferably, both adhesion layer 110 and the printable layer 120 cover all portions of second top surface 80, while release material 100 covers only a preselected portion of second top surface 80.

Although printable layer 120, adhesion layer 110, and patterned release material 100 are described as distinct coatings applied to second portion 24, printable layer 120 and adhesion layer 110 may be applied in a single coating, or may be distinct coatings applied in a single coating operation. Additionally, printable layer 120, the adhesion layer 110, and patterned release material 100 may be applied as a coating, such as a lacquer, or may be applied as a film, to the second portion 24.

As best seen in FIG. 3, label 20 includes a third layer, or third portion, 140. Third portion 140 includes a fifth linear edge 142, a sixth linear edge 144, a fifth lateral edge 146, a sixth lateral edge 148, a third top surface 150, a third bottom surface 152, defining a third body 154, having a thickness T3 therebetween.

The third portion 140 has an adhesive 160 on at least portions of the third bottom surface 152 with a release liner 164 coupled thereto. In other embodiments, the third portion 140 may not have a release liner 164, but may be supplied, for example, in a roll (not shown) with a release compound applied to third top surface 150 to prevent adhesive 160 from adhering to the third top surface 150. Further embodiments may use a polypropylene on the third top surface 150 to prevent the adhesive 160 from adhering to the third top surface 150, thereby permitting the roll to readily unroll as desired. Similarly, the second portion 24, in other embodiments, may not have a release liner 94.

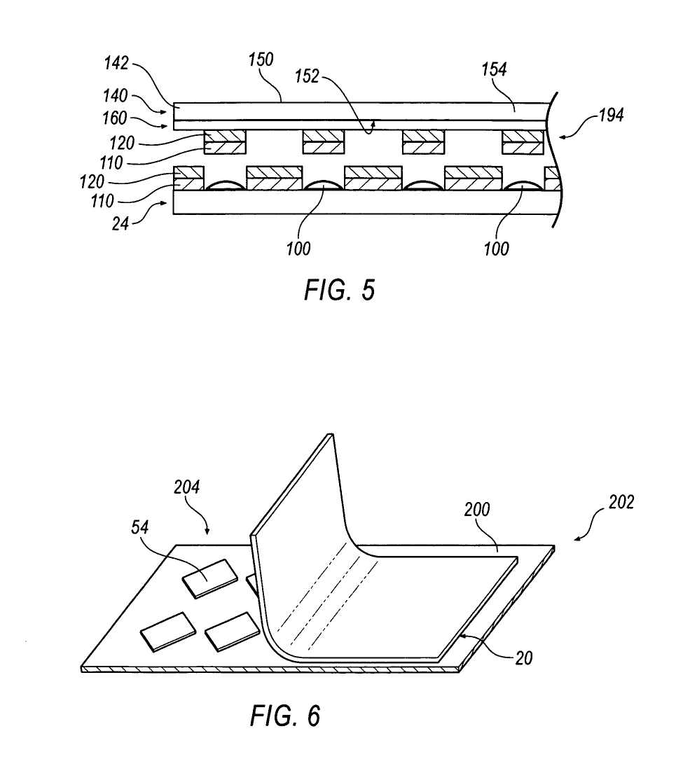

FIG. 5 illustrates a label 20 as partially defaced according to an embodiment, in a first tampered configuration 194, as described in greater detail below. FIG. 6 illustrates the label 20 partially attached to a surface 200 of an object 202 according to an embodiment. A portion of label 20 shown in FIG. 6 is in a second tampered configuration 204, as discussed in greater detail below.

In an exemplary embodiment, label 20 is assembled as follows. First portion 22, with adhesive 60 and the release liner 64 attached thereto, is cut to a desired profile, which may include forming at least one of the first linear edge 32, the second linear edge 34, the first lateral edge 36 and the second lateral edge 38. The first portion 22 may then be die cut, or processed in a similar cutting operation, to form cuts 50 which define shapes 54. In most embodiments, the die cutting operation does not cut through release liner 64.

After first portion 22 is cut, release coating 70 is applied to top surfaces 56 of shapes 54. In an embodiment, as noted above, the release coating 70 is applied in liquid form as a lacquer. The release coating 70 may then be permitted to cure, or may be constructed of a material that does not require any curing. In another embodiment, the release coating 70 may be applied before a cutting operation. In other embodiments, a segregated portion, such as at least one of the shapes 54, and a lift portion, such as the first lift portion 58, are segregated by a method does not include die cutting, but may include applying a degrading material (not shown) on the first top surface 40 or the first bottom surface 42 about the periphery of a desired segregated portion. The degrading material is capable of degrading first portion 22 sufficiently to separate the desired segregated portion from the lift portion.

Second portion 24 may then be applied to the first portion 22 as follows. The release liner 94 (if present) is removed from the adhesive 90 and the second portion 24 is positioned adjacent the first top surface 40. The second portion 24 is then coupled to the first portion 22, with the release coating 70, in the arrangement described above, interposed therebetween.

The release material 100 is then coupled to the second top surface 80 in a desired pattern. Preferably, the pattern formed by the release material 100 is formed as a plurality of spaced, generally parallel, thin bars that are substantially diagonally positioned relative to at least one of the third linear edge 72, the fourth linear edge 74, the third lateral edge 76, and the fourth lateral edge 78. The release material 100 may be silicon based, or other suitable material. If a barcode is to be applied to the label 20, the bars of the barcode are preferably diagonally arranged relative to the bars.

The adhesion layer 110 is then applied to the second top surface 80 of the second portion 24 and the upper surface 104 of the release material 100. Preferably, the adhesion layer 110 forms a continuous coating over the second top surface 80, such that all portions of the release coating are covered by at least a portion of the adhesion layer 110.

The printable layer 120 is then applied, or coupled to, the adhesion layer 110. In this manner, the adhesion layer provides a suitable bond between the printable layer 120 and the second top surface 80 and the patterned release material 100.

Thus assembled, an intermediate label 170, as shown in FIGS. 2 and 3, is produced. The intermediate label 170, as described above, includes the first portion 22 and the second portion 24, with a release material 100 and a printable portion, such as the printable layer 120 coupled thereto.

The label 20 may be supplied to a customer, or end user, as the intermediate label 170 and the third portion 140. The user may print desired graphics, such as the graphics 130, on the printable portion, such as the printable layer 120, couple the third portion 140 to the intermediate label 170, and then cut the label 20 to any desired shape (with one possible shape shown in FIG. 4). Preferably, all of the edges 32, 34, 36, 38, 72, 74, 76, 78, 142, 144, 146, and 148 are formed or modified in a final trimming operation to provide a label 20 with flush edges of each of the first portion 22, the second portion 24, and the third portion 140, thereby reducing unnecessary degradation or tampering, such as may occur with labels that have layers with non-flush edges.

A continuous roll (not shown) of first portions 22 and second portions 24 may be provided using the above described exemplary assembly method, as die cutting the first portion 22 may be desirably performed in a continuous operation. The roll may include the intermediate label 170 in a matrix defined by any number of intermediate labels 170 in width or length, or in an indefinite number of desired intermediate labels of as yet indeterminate width and/or length, and the individual labels 20 cut to desired dimensions either before or after printing.

While in an exemplary embodiment the label 20 includes first portion 22 to the second portion 24 prior to the application of the printable layer 120, the adhesion layer 110, and the patterned release material 100, the order of the assembly of the label 20 may be varied.

To print graphics 130 on the intermediate label 170, a user may utilize a thermal transfer printer (not shown) to apply the graphics 130 to the intermediate label 170 when the printable layer 120 is a thermal transfer receptive material. In other embodiments, printable layer 120 may include a material activated by other sources, or other energy sources, such as a UV activated material, and the graphics 130 may be applied by activating desired portions of the material. In another embodiment, the graphics 130 may be applied by an ink jet printer or the graphics 130 may be applied some other printing device known to those of skill in the art. Once the graphics 130 are applied, the third portion 140 is then coupled to the printable layer upper surface 124. The label 20 may then be trimmed, as described herein. In other embodiments, the graphics 130 may be applied to the printable layer 120 after, or as, the third layer is coupled to the printable layer 120.

In this manner, individual graphics may be printed, or otherwise applied, to the label 20 as desired. The label 20 provides a label that may be customized on demand as labels are needed. The label 20 may then be applied to the surface of an article, such as the surface 200, as described herein.

To apply the label 20 to a desired surface 200 of an article 202, the release liner 64 is removed from the adhesive 60, and then the label 20 is coupled to the surface 200, preferably by applying pressure thereto. Preferably, the adhesion between the adhesion layer 110 and the printable layer 120 is greater than the adhesion between the release material 100 and the second top surface 80 (or the adhesion between the release material 100 and the adhesion layer 110), and the adhesion between the printable layer 120 and the third portion 140. Additionally, the adhesion between the release material 100 and the second top surface 80 (or the adhesion between the release material 100 and the adhesion layer 110) and the adhesion between the printable layer 120 and the third portion 140 are generally both greater than the rupture strength of both the adhesion layer 110 and the printable layer 120.

In this manner, attempted removal of the third portion 140 from the second portion 24 will result in a shear and/or tensile tearing of the adhesion layer 110 and printable layer 120, providing a first tampered configuration 194 as best illustrated in FIG. 5. After an attempted removal of the third portion 140 from the second portion 24, the graphics 130 will be defaced as a portion of the graphics 130 within the printable layer 120 remains attached to the third portion 140, and a portion of the graphics 130 within the printable layer 120 remains attached to the second portion 24. Attempts to reapply the third portion 140 to the second portion 24 will be difficult if not practically impossible because all adhesives will have set or cured and will not re-adhere the portions of the label 20, and the shear tearing within the printable layer 120 will generally distort graphics 130 sufficiently for the attempted tampering to be evident, or for a bar code reader, or other identifying device (not shown) to either not be able to decode any coded indicia, such as (a portion of) graphics 130, or to identify label 20 as potentially tampered.

While adhesion layer 110 and the printable layer 120 are described herein as being two coatings applied as two layers, interaction between adhesion layer 110 and printable layer 120 may resulting a non-homogeneous layering that may resemble a single layer (not shown) or in an emulsive layering that may resemble more than two layers. This interaction may be thermal, cross linking, chemical or mechanical blending, or other interaction that obfuscates any boundary between the adhesion layer 110 and the printable layer 120. This interaction is not viewed as undesirable in most embodiments, and may be beneficial in evincing attempted tampering.

Preferably, the adhesive 90 forms a stronger bond between first lift portion 58 of first portion 22 of label 20 and the second portion 24 of label 20 than the bond formed by the adhesive 60 between first portion 22 and surface 200. Additionally, the adhesive 60 preferably forms a stronger bond between first portion 22 and desired surface 200 than the bond formed by the adhesive 90 between the shapes 54 and the second portion 24 (due to the existence of the release coating 70). In this manner, attempted removal of the second portion 24 from the desired surface 200 will result in the removal of the first lift portion 58 from the surface 200 with the second portion 24, and the shapes 54 remaining adhered to the desired surface 200, providing a second tampered configuration 204, as best seen in FIG. 6. The shapes 54 may be arranged in the second tampered configuration 204 to form a readily recognizable word or symbol that is associated with unauthorized label removal and/or tampering. For labels that include a warning message or symbol, the shapes 54 may be arranged to provide the warning message or symbol in lieu of, or in addition to, providing evidence of tampering.

One example of the use of label 20 includes attaching the label 20 to a surface of an article 202. Attempts to remove the label 20 will alter graphics 130. When a barcode reader is subsequently used to identify the package, the package will be identified as a tampered package. Attempts to entirely remove the label 20 from the article 202 without first removing the third layer 140 for the label 20 may result in the surface 200 of the article 202 having a recognizable indicia of tampering, and the remaining portions of the label stretched such that the graphics 130 are distorted.

In the embodiment illustrated, first portion 22 is an opaque material, and the third portion 140 is a clear material. Additionally, the adhesive 160 is an adhesive that is clear after adhesion of the third portion 140 to the second portion 24. The second portion 24 may be a clear material with a thickness of a varying range, such as 1-3 mils.

First portion 22 is preferably an opaque polyethylene terephthalate (PET) film with a thickness T1 (See FIG. 1) of about 1-2 mils thickness, and the second body 84 of the second portion 24 is preferably a clear PET film of about 2 mils thickness. The third body of the third portion 140 is preferably a clear PET film of about 1 mil thickness. The adhesives 60, 90, are preferably a permanent adhesive known to those skilled in the art, with a thickness of about 1.8 mils. The adhesive 160 is preferably a permanent adhesive known to those skilled in the art, with a thickness of about 0.5 mils. The release liners 64, 94, 164 are preferably a 40 lb paper liner, as known to those of skill in the art. The release coating 70 is generally constructed of a material that will not degrade during the application of the graphics. While preferred thicknesses and materials have been presented for embodiments, one of skill in the art would recognize that other materials or thicknesses could be used in other embodiments, as desired.

While printable layer 120 is described herein as a thermal transfer material applied as a coating, printable layer 120 may be other materials, such as a ultraviolet (UV) curable ink, or other materials suitable for use as graphics or other indicia on a label. If a UV curable ink is used, then an ink jet printer that activates at least a portion of the UV curable coating may be used to print any desired graphics. Additionally, the label 20, or the intermediate label 170 may be printed after the adhesive 60 is coupled to the surface of a desired article.

In the discussion herein, ‘coupled’ is broadly interpreted and may mean ‘directly attached’ or ‘attached by an adhesive’ or ‘attached via another item,’ or other meaning understood by one of skill in the art.

The preceding description has been presented only to illustrate and describe exemplary embodiments of the methods and systems disclosed and claimed herein. It is not intended to be exhaustive or to limit the claimed invention to any precise form disclosed. It will be understood by those skilled in the art that various changes may be made and equivalents may be substituted for elements thereof without departing from the scope of the claimed subject matter. In addition, many modifications may be made to adapt a particular situation or material to the teachings without departing from their essential scope. Therefore, it is intended that the claimed invention not be limited to the particular embodiment disclosed as the best mode contemplated for carrying out this invention, but that the invention will include all embodiments falling within the scope of the claims. Embodiments may be practiced otherwise than is specifically explained and illustrated without departing from the spirit or scope of the claimed invention. The scope of the invention is limited solely by the following claims.

What is claimed is:

1. An article comprising:
a first portion defined by at least a first top surface and a first bottom surface;
a second portion defined by at least a second edge, a printable portion, a second top surface, and a second bottom surface;
a release coating at least partially interposed between the first portion and the second portion, wherein the release coating inhibits adherence of the second portion to at least portions of the first portion; and
a third portion coupled to the printable portion, wherein the third portion is defined by at least a third top surface and a third bottom surface.

2. The article of claim 1, wherein the first portion comprises is an opaque polyethylene terephthalate.

3. The article of claim 1, wherein the second portion comprises a clear polyethylene terephthalate.

4. The article of claim 1, wherein the second portion has a thickness of about 1 mils to about 3 mils.

5. The article of claim 1, further comprising a release material interposed between the second portion and the printable portion, wherein the release material inhibits adherence of at least portions of the second portion to at least portions of the printable portion.

6. The article of claim 1, wherein said printable surface is defined by a thermal transfer coating.

7. The article of claim 1, wherein the first portion includes a segregated portion and a lift portion, the segregated portion being coupled to a desired labeling surface and the second portion, and further wherein the segregated portion is coupled to the desired label surface with greater adhesion than the adhesion between the segregated portion and the second portion.

8. A tamper evident label comprising:
a first portion is defined, at least in part, by a first top surface, a first bottom surface, a segregated portion and a lift portion;
a second portion defined, at least in part, by a second top surface, a second bottom surface and a printable portion; and
a third portion defined, at least in part, by a third top surface, a third bottom surface;
wherein the second portion is selectively interposed between the first portion and the third portion and the second top surface is at least partially covered by a release material, wherein the release material inhibits adherence of at least portions of the second portion to at least portions of the printable portion.

9. The label of claim 8, wherein the third portion comprises a clear material.

10. The label of claim 8, wherein the first material is an opaque material.

11. The label of claim 8, wherein the release coating is UV curable.

12. The label of claim 8, further comprising a release coating at least partially interposed between the first portion and the second portion, wherein the release coating inhibits adherence of at least portions of the second portion to at least portions of the segregated portion.

13. The label of claim 8, wherein the third portion has a thickness of about 1 mils to about 3 mils.

14. The label of claim 8, further comprising a preselected graphics applied to the printable portion.

15. A method of assembling a tamper evident label comprising:
segregating a predetermined shape in a first layer to define a segregated portion and a lift portion;
applying a release coating to at least a portion of a surface of the segregated portion;
coupling a second layer with at least portions of the first layer, wherein at least portions of the release coating are interposed between the first layer and the second layer, wherein the second layer includes a printable portion and a release material; and
supplying a third layer, wherein the third layer is selectively positioned adjacent at least portions of the second layer.

16. The method of claim 15, further comprising positioning the second layer in contact with at least portions of the first layer.

17. The method of claim 15, wherein segregating the predetermined shape includes cutting the first layer.

18. The method of claim 15, further comprising applying graphics to the printable portion.

19. The method of claim 15, further comprising placing the third layer in contact with at least portions of the second layer, wherein at least portions of the printable portion are interposed between the third layer and the second layer.

20. The method of claim 15, further comprising adhering at least portions of the third layer to at least portions of the printable portion.
